(19) United States
(12) Patent Application Publication
(10) Pub. No.: US 2012/0117131 A1
(43) Pub. Date: May 10, 2012

(54) INFORMATION PROCESSING DEVICE, FILE MANAGEMENT METHOD, AND RECORDING MEDIUM FOR FILE MANAGEMENT PROGRAM

(75) Inventors: Tetsutaro MARUYAMA, Kawasaki (JP); Yoshitake SHINKAI, Kawasaki (JP); Takeshi MIYAMAE, Kawasaki (JP); Kensuke SHIOZAWA, Kawasaki (JP)

(73) Assignee: FUJITSU LIMITED, Kawasaki-shi (JP)

(21) Appl. No.: 13/103,652

(22) Filed: May 9, 2011

(30) Foreign Application Priority Data
May 17, 2010 (JP) 2010-113552

(51) Int. Cl. G06F 17/30; G06F 15/16

(52) U.S. Cl. 707/827; 707/E17.01; 707/E17.032

(57) ABSTRACT

A computer-readable, non-transitory medium storing a program causing a computer to execute a process, the computer being connected through a network to a plurality of file management devices which store a plurality of files distributed in the plurality of file management devices, the process including: extracting an identification information of a file management device by a file descriptor specified in a request for locking a file, the request being generated by an application that is activated on the computer; and transmitting the request for locking the file through an interface section to the file management device corresponding to the identification information.

### CROSS-REFERENCE TO RELATED APPLICATION

This application is based upon and claims the benefit of priority of the prior Japanese Patent Application No. 2010-113552, filed on May 17, 2010, the entire contents of which are incorporated herein by reference.

### FIELD

The present invention relates to an information processing device, a file management method, and a recording medium for a file management program.

### BACKGROUND

A network attached storage (NAS) is a dedicated file server that can be used while being directly connected to a network. The NAS has a feature in which a client of the NAS can use a data storage region that exists on the NAS (server) as if the client had the storage region therein.

Recently, many servers that serve as NASs are used, and network infrastructures have been built. The servers are concentrated and arranged in dedicated spaces called data centers. The reason is that there is an advantage from the perspective of power consumption, cooling, data maintenance and the like. The number of servers that are arranged in a data center has continuously increased with an increase in the size of a region for storing necessary data and is currently extremely large.

When servers are concentrated and arranged in a data center, an administrator of the data center is assigned to manage the many servers. If the management cost could be reduced, concentrating the servers in the data center would be meaningful. In general, however, a single server (NAS server) that serves as an NAS corresponds to a single storage (NAS client) virtualized on a client as illustrated in FIG. 1. Thus, it is difficult to efficiently reduce the management cost only by simply concentrating and arranging the servers in the data center. The storage virtualized on the client is a drive on Windows (registered trademark), for example. What a single NAS server corresponds to a single storage means that the single server is assigned to the single drive, for example.

However, when a plurality of NAS servers are integrated and a single NAS client corresponds to the NAS servers, exclusive control of files that are managed in the plurality of NAS servers cannot be appropriately performed only by simply integrating the plurality of NAS servers. For example, when an NAS client needs to lock a specific file, it is difficult to determine which NAS server needs to be requested for the locking of the file.

Examples of the related art are Japanese Laid-open Patent Publication No. 8-6840 and Japanese Laid-open Patent Publication No. 11-338754.

### SUMMARY

According to an aspect of the invention, a computer-readable, non-transitory medium storing a program causing a computer to execute a process, the computer being connected through a network to a plurality of file management devices which store a plurality of files distributed in the plurality of file management devices, the process including: extracting an identification information of a file management device by a file descriptor specified in a request for locking a file, the request being generated by an application that is activated on the computer; and transmitting the request for locking the file through an interface section to the file management device corresponding to the identification information.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a relationship between a conventional NAS client and a conventional NAS server.

FIG. 2 is a diagram illustrating an example of a configuration of a file management system according to a first embodiment.

FIG. 3 is a diagram illustrating an example of a hardware configuration of a data server device according to the first embodiment.

FIG. 4 is a diagram illustrating an example of a configuration of an L7 switch section, an example of a configuration of an NAS server section and an example of a configuration of a server monitoring section.

FIGS. 5A and 5B are diagrams illustrating an outline of management of name information and file bodies according to the first embodiment.

FIG. 6 is a diagram illustrating an example of name information on one directory.

FIG. 7 is a diagram illustrating a process that is performed when a new data server device starts up.

FIG. 8 is a diagram illustrating an example of a configuration of a data server list storage unit.

FIG. 9 is a diagram illustrating a process that is performed when an existing data server device starts up.

FIG. 10 is a diagram illustrating a process of heartbeat communication.

FIG. 11 is a diagram illustrating a process of creating a file.

FIG. 12 is a diagram illustrating an example of a configuration of a file descriptor according to the embodiment.

FIG. 13 is a diagram illustrating a process of acquiring a file descriptor.

FIG. 14 is a diagram illustrating a process of creating a file when a file descriptor of a parent directory is cached.

FIG. 15 is a diagram illustrating an example of a functional configuration of a client device according to a second embodiment and an example of a functional configuration of a data server device according to the second embodiment.

FIG. 16 is a diagram illustrating a process of locking a file.

FIG. 17 is a diagram illustrating an example of management of a server list in the client device according to the second embodiment.

FIG. 18 is a diagram illustrating a process that is performed in response to restart of the data server device.

FIG. 19 is a diagram illustrating a process that is performed in response to restart of the client device.

### DESCRIPTION OF EMBODIMENTS

Embodiments of the invention are described below with reference to the accompanying drawings. The first embodiment describes management of files distributed and managed in a new file management system. The second embodiment describes exclusive control of files that are managed in the file management system.

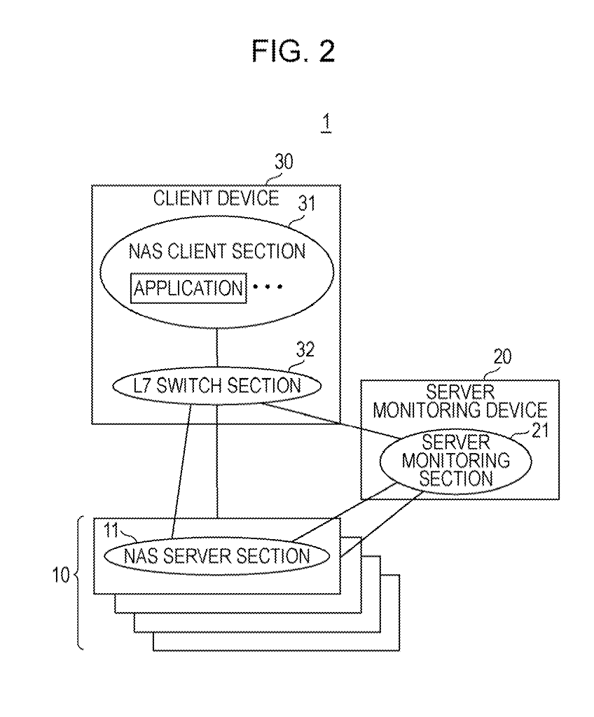

FIG. 2 is a diagram illustrating an example of a configuration of the file management system according to the first embodiment. In FIG. 2, the file management system 1 includes a plurality of data server devices 10, a server monitoring device 20 and at least one client device 30. The devices that are included in the file management system 1 can communicate with each other through a local area network (LAN) or another network (wired or wireless network) such as the Internet.

The data server devices 10 are so-called network attached storage (NAS) servers and each store (manage) a file group in which data is stored. In the present embodiment, files are distributed in and managed by the data server devices 10. The data server devices 10 are an example of file management devices in the present embodiment. The data server devices 10 each have an NAS server section 11. The NAS server section 11 is software that achieves a function of systematically managing files.

The server monitoring device 20 is a computer that monitors the states of the data server devices 10. The server monitoring device 20 has a server monitoring section 21. The server monitoring section 21 is software that monitors the states of the data server devices 10 and manages a list of the data server devices 10 that normally operate.

The client device 30 is a computer that performs an operation on files that are managed by the data server devices 10. The client device 30 has an NAS client section 31, an L7 switch section 32 and the like. The NAS client section 31 includes an application that is executed by at least one of the data server devices 10. The application uses a file that is managed by at least one of the data server devices 10. As an example of the NAS client section 31, software that achieves a file system is used.

The L7 switch section 32 is an example of intermediating means. The L7 switch section 32 is software that achieves a virtual network switch. The plurality of data server devices 10 are virtualized as a single data server device by the L7 switch section 32. Thus, the NAS client section 31 treats the L7 switch section 32 as a single data server device 10. As a result, the NAS client section 31 can use files distributed in the plurality of data server devices 10 through a conventional NAS protocol without being aware of the existences of the plurality of data server devices 10. As the conventional NAS protocol, Network File System (NFS), Common Internet File System (CIFS), or the like is used, for example.

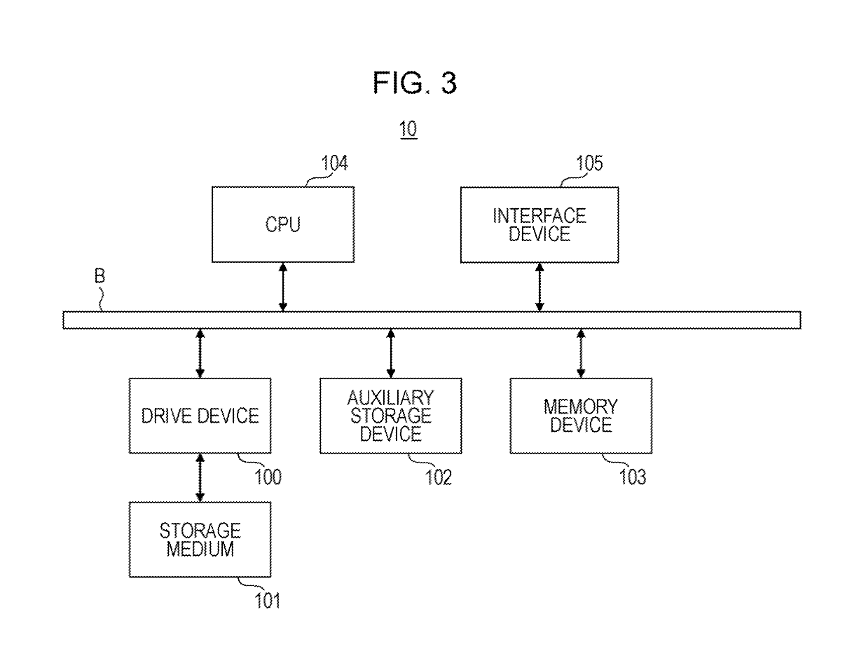

FIG. 3 is a diagram illustrating an example of a hardware configuration of the data server device according to the present embodiment. The data server device 10 illustrated in FIG. 3 includes a drive device 100, an auxiliary storage device 102, a memory device 103, a CPU 104 and an interface device 105, which are connected to each other through a bus B.

A program that achieves a process to be performed by the data server device 10 is provided by a storage medium 101 such as a CD-ROM. When the storage medium 101 that has, stored therein, the program is set in the drive device 100, the program is installed from the storage medium 101 into the auxiliary storage device 102 through the drive device 100. However, the program may not be installed from the storage medium 101. For example, the program may be downloaded by another computer through the network and installed into the auxiliary storage device 102. The auxiliary storage device 102 stores the installed program, files to be managed and the like.

When an instruction to execute the program is issued, the memory device 103 reads the program from the auxiliary storage device 102 and stores the read program. The CPU 104 executes a function of the data server device 10 according to the program stored in the memory device 103. The interface device 105 is used as an interface to connect the data server device 10 to the network.

The server monitoring device 20 and the client device 30 may each have the same configuration as illustrated in FIG. 3.

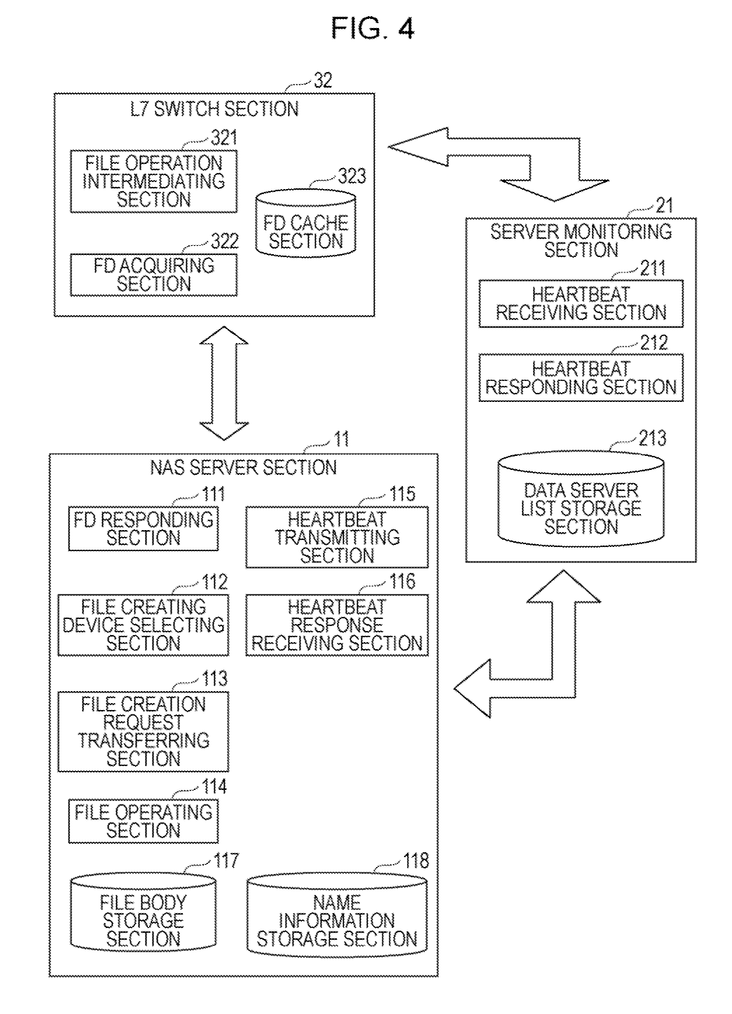

FIG. 4 is a diagram illustrating an example of a configuration of the L7 switch section, an example of a configuration of the NAS server section and an example of a configuration of the server monitoring section.

As illustrated in FIG. 4, the L7 switch section 32 includes a file operation intermediating section 321, an FD acquiring section 322 and an FD cache section 323. The file operation intermediating section 321 receives, from the NAS client section 31, a request for an operation to be performed on a file based on the NAS protocol. The file operation intermediating section 321 determines a data server device 10 that needs to perform the operation (creation, reading, writing or the like), and the file operation intermediating section 321 transfers the request for the operation to the NAS server section 11 of the determined data server device 10. A file descriptor that corresponds to the request for the operation is specified in the request (for the operation to be performed on the file) transferred to the NAS server section 11. The file descriptor (hereinafter referred to as an FD) is also called a file handle depending on an operating system (OS). The FD is generally used as information to specify the file to be subjected to the operation. When the request for the operation is creation of the file, the FD that corresponds to the request for the operation corresponds to an FD of a directory where the file is created. In addition, when the request for the operation is reading or writing of the file, the FD corresponds to an FD of the file to be subjected to the operation. When files are classified and managed in a tree structure, the directory is a virtual file storage location that corresponds to each of nodes of the tree structure. The directory is also called as a folder depending on the OS.

The FD acquiring section 322 searches an FD to be used by the file operation intermediating section 321 on the basis of a directory corresponding to the FD or the name of a path of the file. The FD cache section 323 causes a predetermined number of FDs used by the file operation intermediating section 321 to be temporarily stored in a storage device of the client device 30.

The NAS server section 11 includes an FD responding section 111, a file creating device selecting section 112, a file creation request transferring section 113, a file operating section 114, a heartbeat transmitting section 115, a heartbeat response receiving section 116, a file body storage section 117 and a name information storage section 118.

The FD acquiring section 322 of the L7 switch section 32 transmits a request to acquire an FD, and the FD responding section 111 transmits, in response to the request to acquire the FD, the FD of a directory or file corresponding to a path name specified in the request to acquire the FD. The file operation intermediating section 321 of the L7 switch section 32 transmits a request to create a file, and the file creating device selecting section 112 selects, on the basis of the request to create the file, a data server device 10 in which the file is created. The file creation request transferring section 113 transfers the request to create the file to the selected data server device 10 in which the file is created. In the present embodiment, the data server device 10 that is requested to create the file does not necessarily create the file corresponding to the request to create the file and does not necessarily store the created file in the auxiliary storage unit 102 of the data server device 10. The file operating section 114 executes a process corresponding to the request (for the operation to be performed on the file) transferred by the file operation intermediating section 321 or the file creation request transferring section of another data server device 10. The heartbeat transmitting section 115 periodically transmits, to the server monitoring device 20 through a communication method generally called heartbeat communication, a notification (heartbeat) that indicates that the data server device 10 normally operates. The heartbeat transmitting section 115 causes information (hereinafter referred to as data server information) such as information on the identification of the interested data server device 10 and statistical information on the state of a load to be included in the heartbeat. The heartbeat response receiving section 116 receives, from the server monitoring device 20, a response to the heartbeat and causes information on a list of the data server devices 10 to be stored in the auxiliary storage device 102. In this case, the information on the list of the data server devices 10 is included in the response (to the heartbeat) transmitted from the server monitoring device 20.

The file body storage section 117 causes a body (actual body) of a file assigned to the interested data server device 10 to be stored in the auxiliary storage device 102. The name information storage section 118 causes name information (location information) on a directory assigned to the interested data server device 10 to be stored in the auxiliary storage device 102. The name information on the directory is a group of name information (location information) on files or directories, which are located immediately under the interested directory.

In an NAS, as information on a file, three types of information, which are a file body, information on an attribute of the file and information on the name of the file, are managed in general. The file body is the actual body of the file. The attribute information indicates the attribute of the file. A part of the attribute information is a date and time of creation of the file, a date and time of reference of the file, the data size and the like. The name information is convenient information that makes people easily manage data. The name information achieves a directory structure and is information to add a path name and a file name to each of files. The name information is managed on a directory basis. For example, name information on a certain directory includes information on the certain directory, information on a parent directory of the certain directory, and information on a file or directory, which is stored immediately under the certain directory. The attribute information and the name information are collectively called meta information. The meta information is also managed as information on directories. In the present embodiment, among the constituent information, the file bodies are stored in the file body storage section 117, and the name information is stored in the name information storage section 118.

In the present embodiment, the name information is managed separately from the file bodies. The name information is not only simply managed separately from the files but also distributed in and managed by the plurality of data server devices 10.

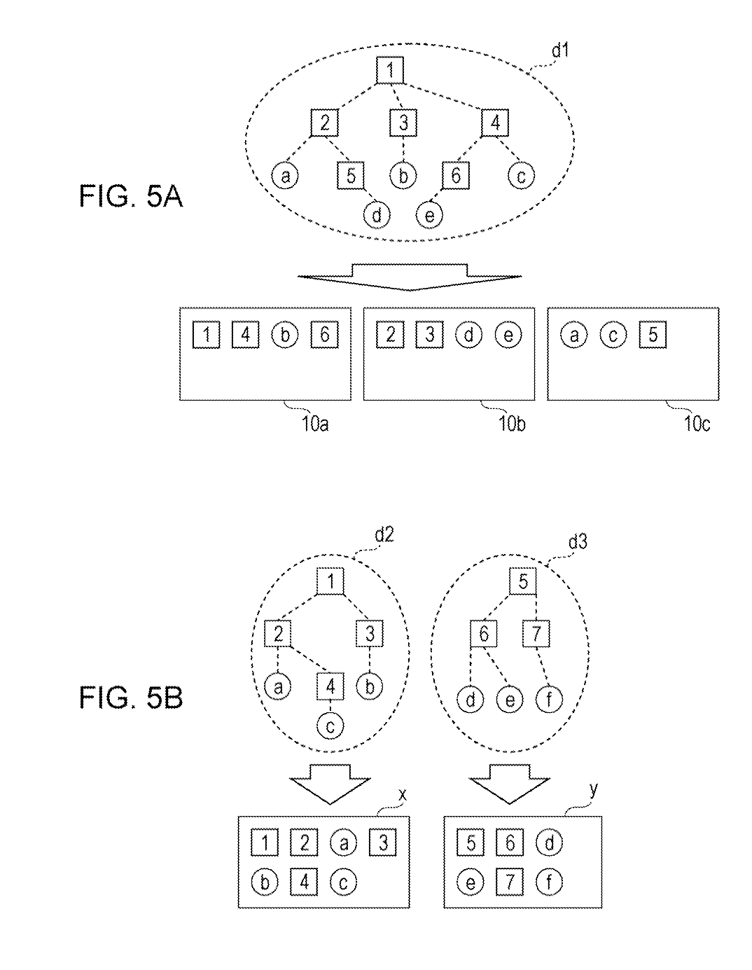

FIGS. 5A and 5B are diagrams illustrating an outline of management of the name information and the file bodies according to the present embodiment. In FIG. 5A, d1 indicates a directory structure. Quadrangles indicate the name information on directories, and circles indicate the file bodies.

In an example illustrated in FIG. 5A, name information on directories 1, 4 and 6 and a file body of a file b are managed by a data server device 10a. Name information on directories 2 and 3 and file bodies of files d and e are managed by a data server device 10b. Name information on a directory 5 and file bodies of files a and c are managed by a data server device 10c. In this manner, the name information on the directories that belong to the single directory structure (corresponding to a single root directory) is distributed in and managed by the data server devices 10 regardless of parent-child relationships among the directories. What the name information is managed regardless of the parent-child relationships means, for example, that the name information on the directories 2 and 3 that are child directories of the directory 1 is not necessarily managed by the data server device 10 that manages the directory 1.

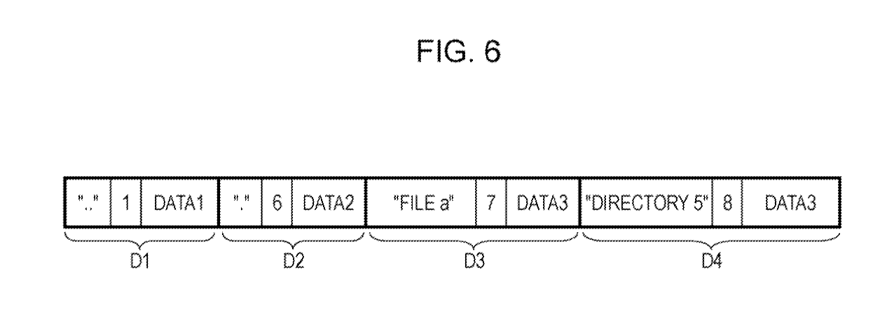

FIG. 6B illustrates, for reference, management of name information in a normal NAS in which a single client device corresponds to a single data server device. In FIG. 6B, name information on directories that belong to a single tree structure and file bodies that belong to the single tree structure are managed by a single data server device. For example, name information on directories that belong to a directory structure d2 and file bodies that belong to the directory structure d2 are managed by a data server device x. Name information on directories that belong to a directory structure d3 and file bodies that belong to the directory structure d3 are managed by a data server device y.

In the present embodiment, the attribute information is attached to the file body and managed. In other words, the attribute information is attached to the file body and stored in the file body storage section 117. The reason is that the file bodies and the attribute information are used in many cases. The attribute information may be attached to the name information and managed.

Since the name information is distributed and managed as illustrated in FIG. 5A, the name information on each of directories has a structure illustrated in FIG. 6.

FIG. 6 is a diagram illustrating an example of the name information on a single directory. FIG. 6 illustrates the name information on the “directory 2” illustrated in FIG. 5A.

The name information includes data D1 on the parent directory 1, data D2 on the current directory 2, data D3 on the file a and data D4 on the directory 5. The data each includes three items: a name, a file ID and a data server ID. The name is the name of the file or directory. However, the name of the parent directory is indicated by “..”, and the name of the current directory is indicated by “.”. The reason is that the actual value of the name of each of the directories is recorded in the name information on the parent directory of the interested directory. The file ID is the identifier of the file or directory. The server ID is the server ID of the data server device 10 to which the directory or file is assigned. The server ID is information on the identification of each of the data server devices 10. Any information can be used as the server IDs as long as the data server devices 10 can be identified. For example, IP addresses or host names may be used as the server IDs.

In the present embodiment, the file or directory is uniquely specified by the combination of the file ID and the server ID. The data server device 10 to which the directory is assigned is the data server device 10 that manages the name information on the interested directory. In addition, the data server device 10 to which the file is assigned is the data server device 10 that has, stored therein, the body of the interested file.

For example, when referring to the data D3, it is apparent that the body of the file a is stored in the data server device 10 that has the file ID “7” of the file a and the server ID “DATA 3”. In addition, when referring to the data D4, it is apparent that the directory 5 is assigned to the data server device 10 that has the file ID “8” of the directory 5. A plurality of directories may be assigned to a single data server device 10. A data server device 10 to which no directory is assigned may exist.

Return to FIG. 4. The server monitoring section 21 includes a heartbeat receiving section 211, a heartbeat responding section 212 and the like. The heartbeat receiving section 211 receives a notification from each of the data server devices 10 through heartbeat communication and causes data server information included in the notification to be stored in a data server list storage section 213. The heartbeat responding section 212 transmits, to each of the data server devices 10, a list of the data server information transmitted from the data server devices 10 and stored in the data server list storage section 213. Thus, the data server devices 10 can each detect the states and the like of the other data server devices 10.

Next, a process that is performed by the file management system 1 is described. First, a process that is performed when the data server device 10 starts up is described below.

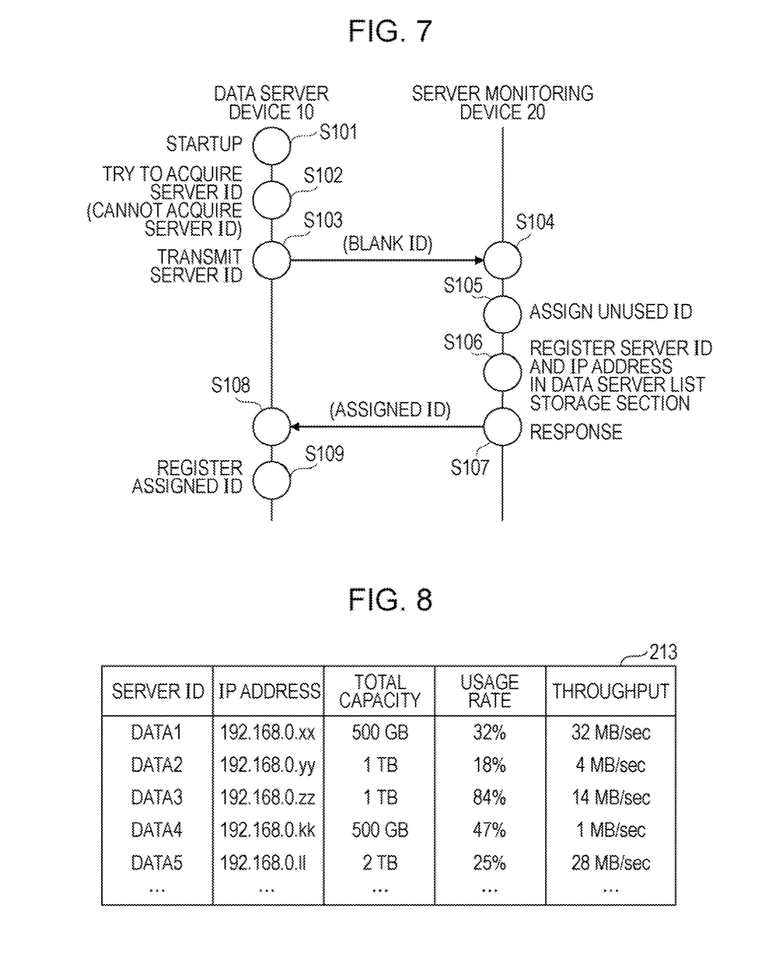

FIG. 7 is a diagram illustrating the process that is performed when a new data server device 10 starts up is described below. The new data server device 10 means the data server device 10 that starts up as a constituent element of the file management system 1 for the first time.

When the new data server device 10 starts up (in step S101), the heartbeat transmitting section 115 of the interested data server device 10 tries to acquire the server ID of the interested data server device 10 from a predetermined storage region of the interested data server device 10 (in step S102). The server ID is an ID that is assigned to the data server device 10 whose existence has been detected by the server monitoring device 20 in the past. However, since the interested data server device 10 is the new data server device 10, the existence of the interested data server device 10 is yet to be detected by the server monitoring device 20. Thus, the server ID is yet to be assigned to the interested data server device 10. Therefore, the server ID is not acquired in step S102.

Subsequently, the heartbeat transmitting section 115 transmits, to the server monitoring device 20, a notification that specifies a blank server ID and an IP address and indicates the startup of the interested data server device 10 (in step S103). When the heartbeat receiving section 211 of the server monitoring device 20 receives the notification (in step S104), the heartbeat receiving section 211 assigns an unused server ID to the interested data server device 10 on the basis of the blank server ID specified in the notification (in step S105). Then, the heartbeat receiving section 211 creates a new record so that the data server list storage section 213 has the new record. Then, the heartbeat receiving section 211 causes the server ID and the IP address to be stored (registered) in the created record (in step S106).

FIG. 8 is a diagram illustrating an example of a configuration of the data server list storage section. As illustrated in FIG. 8, the data server list storage section 213 stores a server ID, an IP address, a total capacity, a usage rate, a throughput and the like for each of the data server devices 10 that are operating. The total capacity is a total capacity of the auxiliary storage device 102 of the data server device 10. The usage rate is a usage rate of the auxiliary storage device 102. The throughput is a recent actual communication amount (actual communication amount for a predetermined past time period). The total capacity, the usage rate, the throughput and the like are examples of statistical information that indicates the state of the data server device 10 or a load of the data server device 10. Thus, other information may be managed in the data server list storage section 213.

In step S106, the server ID and the IP address are stored in the new record. In step S103, however, the total capacity, the usage rate, the throughput and the like may be transmitted by the heartbeat transmitting section 115. In this case, the total capacity, the usage rate, the throughput and the like are recorded in the new record.

Then, the heartbeat responding section 212 transmits the server ID to the data server device 10 (in step S107). In this case, the server ID and data (list of the data server information) stored in the data server list storage section 213 may be transmitted to the data server device 10 by the heartbeat responding section 212.

When the heartbeat response receiving section 116 of the interested data server device 10 receives the server ID (in step S108), the heartbeat response receiving section 116 causes the received server ID to be stored in a predetermined storage region as a server ID assigned to the interested data server device 10 (in step S109). In addition, when the heartbeat response receiving section 116 receives the list of the data server information, the heartbeat response receiving section 116 causes the list to be stored in the predetermined storage region.

In this manner, the interested data server device 10 is registered in the server monitoring device 20. In addition, the server ID is assigned to the interested data server device 10 by the server monitoring device 20. Thus, the interested data server device 10 can be identified on the basis of the server ID in the file management system 1. When the data server device 10 stops, the heartbeat transmitting section 115 transmits, to the server monitoring device 20, a notification that indicates the stop and specifies the server ID. The heartbeat receiving section 211 of the server monitoring device 20 deletes, from the data server list storage section 213, a record related to the server ID specified by the notification that indicates the stop.

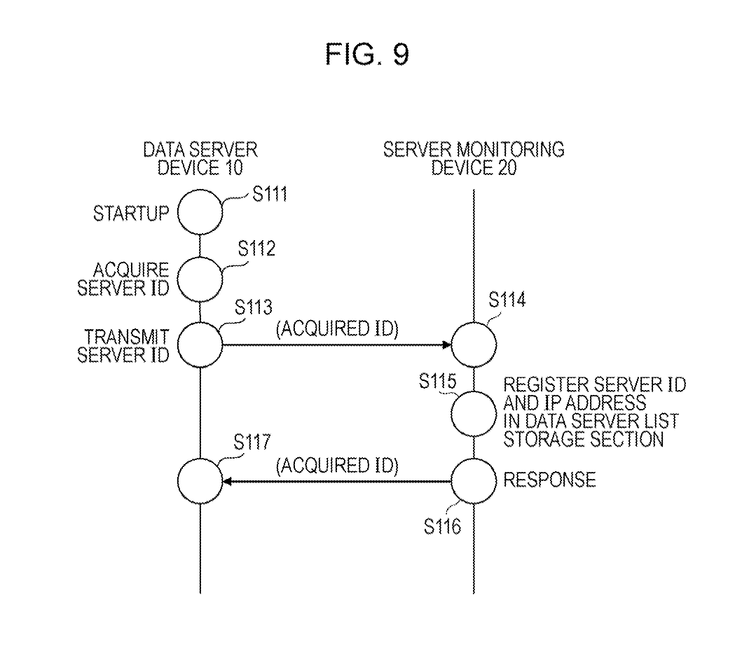

Next, a process that is performed when an existing data server device 10 starts up is described. FIG. 9 is a diagram illustrating the process that is performed when the existing data server device 10 starts up. The existing data server device 10 is a data server device 10 to which a server ID has been assigned in the past.

When the existing data server device 10 starts up (in step S111), the heartbeat transmitting section 115 of the interested data server device 10 acquires the sever ID from the predetermined storage region of the interested data server device 10 (in step S112). Since the interested data server device 10 is an existing data server device 10, the server ID is normally acquired.

Then, the heartbeat transmitting device 115 transmits, to the server monitoring device 20, a notification that specifies the server ID and the IP address and indicates the startup of the interested data server device 10 (in step S113). When the heartbeat receiving section 211 of the server monitoring device 20 receives the notification (in step S114), the heartbeat receiving section 211 creates a new record so that the data server list storage section 213 has the new record. Then, the heartbeat receiving section 211 causes the server ID and the IP address to be stored (registered) in the created record on the basis of the server ID specified in the notification (in step S115). In step S113, the total capacity, the usage rate, the throughput and the like may be transmitted by the heartbeat transmitting section 115. In this case, the total capacity, the usage rate, the throughput and the like are recorded in the new record.

Then, the heartbeat responding section 212 transmits the server ID to the interested data server device 10 (in step S116). The heartbeat responding section 212 may transmit the server ID and the data (list of the data server information) stored in the data server list storage section 213.

The heartbeat response receiving section 116 of the interested data server device 10 detects, on the basis of reception of the server ID, that the interested data server device 10 is normally registered in the server monitoring device 20 (in step S117). When the heartbeat response receiving section 116 receives the list of the data server information, the heartbeat response receiving section 116 causes the list to be stored in the predetermined storage region.

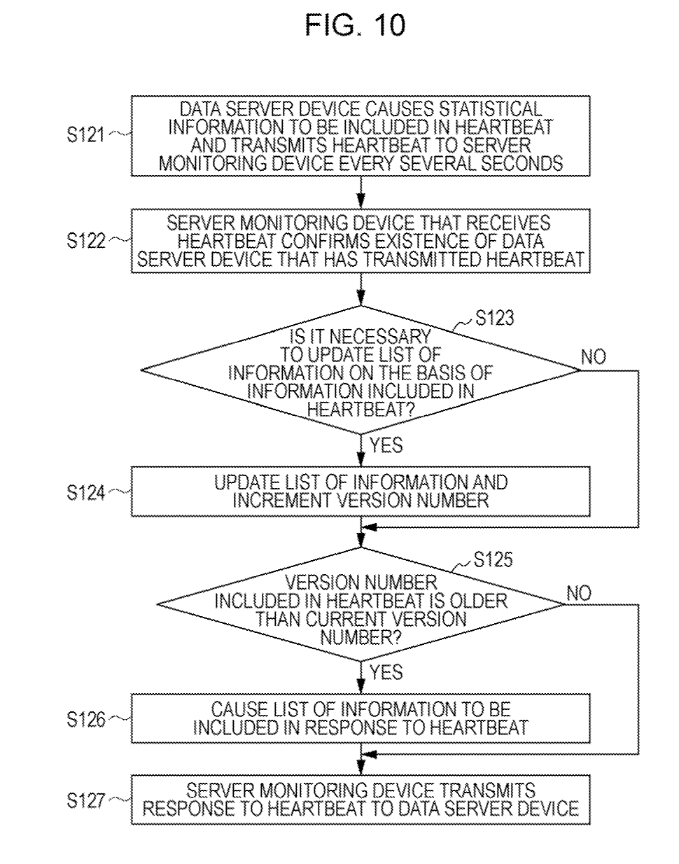

Next, a process of the heartbeat communication that is continuously performed after the startup of the data server device 10 is described. FIG. 10 is a diagram illustrating the process of the heartbeat communication.

In step S121, the heartbeat transmitting section 115 of the data server device 10 transmits a heartbeat to the server monitoring device 20 every several seconds. The heartbeat receiving section 211 of the server monitoring device 20 detects, on the basis of reception of the heartbeat, that the data server device 10 that corresponds to the server ID included in the heartbeat exists (normally operates) (in step S122). In the present embodiment, the heartbeat includes: the server ID; the statistical information (the total capacity, the usage rate, the throughput and the like) indicating the state of the interested data server device 10 or a load of the interested data server device 10; and a version number of the list of the data server information held by the data server device 10 that has transmitted the heartbeat. The version number also corresponds to a version number of the data (i.e., the list of the data server information) stored in the data server list storage section 213. The version number is updated by updating the data stored in the data server list storage section 213.

Then, the heartbeat receiving section 211 determines, on the basis of the received heartbeat, whether or not it is necessary to update the data server list storage section 213 (in step S123). Specifically, the heartbeat receiving section 211 determines whether or not there is the difference between information included in the heartbeat and information that is associated with the server ID included in the heartbeat and is stored in the data server list storage section 213.

When there is the difference (Yes in step S123), the heartbeat receiving section 211 updates the data server list storage section 213 on the basis of the information included in the heartbeat. In addition, the heartbeat receiving section 211 increments the version number of the data stored in the data server list storage section 213 (in step S124). When there is no difference (No in step S123), step S124 is not performed and the process proceeds to step S125.

Subsequently, the heartbeat responding section 212 determines whether or not the version number included in the heartbeat is older than the current version number (in step S125). When the version number included in the heartbeat is older than the current version number (Yes in step S125), the heartbeat responding section 212 causes the current data stored in the data server list storage section 213 and the version number of the current data to be included in a response to the heartbeat. Then, the heartbeat responding section 212 transmits the response to the heartbeat to the device that has transmitted the heartbeat (in step S127).

As described above, in the present embodiment, the version of the list of the data server information is managed. The version number of the list of the data server information held by the data server device 10 is included in the heartbeat. When the interested version number is older than the version number managed by the server monitoring device 20, the latest list of the data server information is transmitted. Thus, it is possible to suppress an increase (caused by including the list of the data server information in the response to the heartbeat) in a communication load.

The list (of the data server information) that is included in the response in step S126 may be limited to the difference between data related to the version number included in the heartbeat and the current data stored in the data server list storage section 213. In this case, the server monitoring device 20 has, stored therein, lists of data server information for a predetermined number of past versions. Thus, the server monitoring device 20 can acquire the list (of the data server information) corresponding to the version number specified by the heartbeat and acquire the difference between the data related to the version number included in the heartbeat and the latest data.

The server monitoring device 20 deletes, from the data server list storage section 213, a record of a data server device 10 from which the server monitoring device 20 does not receive the heartbeat for a predetermined time period. Specifically, a date and time when the last heartbeat is received from each of the data server devices 10 are stored in the data server list section 213, although the date and time are not illustrated in FIG. 8. The server monitoring device 20 automatically deletes a record that is not updated for a predetermined time after the data and time of reception of the last heartbeat.

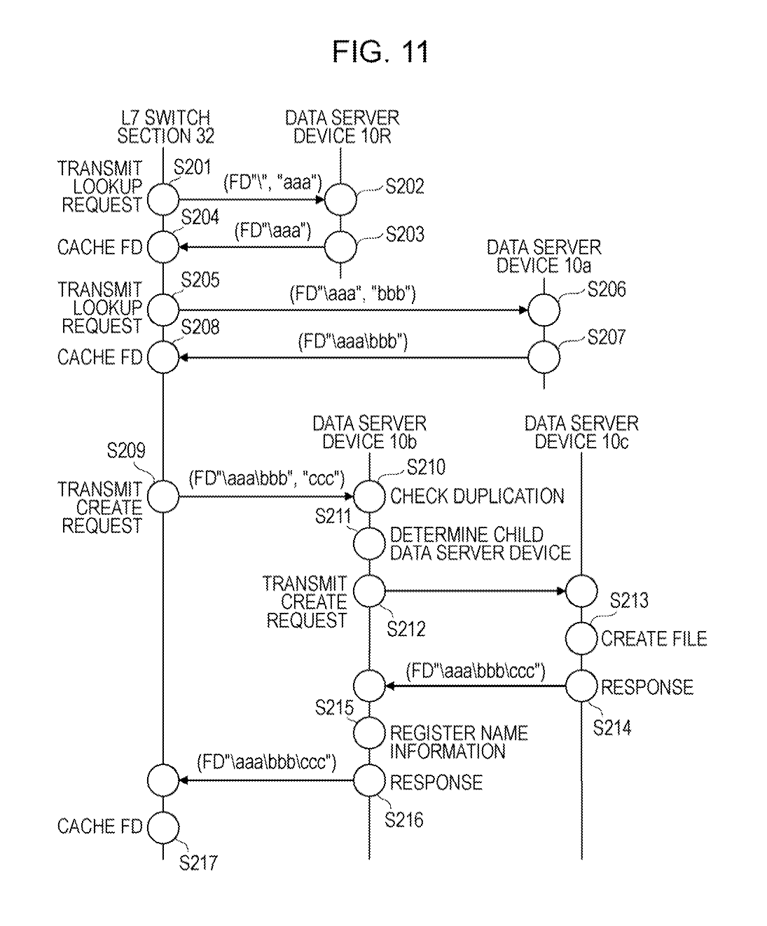

Next, a process of creating a file is described. FIG. 11 is a diagram illustrating the process of creating a file. The process illustrated in FIG. 11 starts when the file operation intermediating section 321 of the L7 switch section receives a request (CREATE command) to create a file from the NAS client section 31 in the client device 30. The name of a path of a file to be created is specified in the CREATE command. In the following example, a file with a file name “ccc” is requested to be created in a directory “\aaa\bbb”. Thus, as the path name, “\aaa\bbb\ccc” is specified. It is assumed that the FD cache section 323 has no data in an initial state of FIG. 11.

In the present embodiment, directories and files are distributed in and assigned to the plurality of data server devices 10. Thus, the file operation intermediating section 321 first requests the FD acquiring section 322 to acquire an FD of the directory “\aaa\bbb” in which the file “ccc” is created. The FD acquiring section 322 acquires the FD of the directory “\aaa\bbb” by searching directory layers on a layer basis from a root directory “\”.

Specifically, in step S201, the FD acquiring section 322 transmits a LOOKUP request (request to acquire the FD) to search a directory “aaa” located immediately under the root directory “\” to a data server device 10R to which the root directory “\” has been assigned. In the present embodiment, information (server ID, IP address and the like) on the identification of the data server device 10R to which the root directory has been assigned is preset in the FD acquiring section 322. In step S201, the LOOKUP request is transmitted to the data server device 10R on the basis of the information that is a set value and indicates the identification of the data server device 10R. When the server ID is set as the information on the identification of the data server device 10R, the FD acquiring section 322 inquires of the server monitoring device 20 about the IP address corresponding to the server ID. In addition, the L7 switch section 32 may periodically acquire the list of the information on the data server devices 10 from the server monitoring device 20 and cause the acquired list to be stored in the storage device of the client device 30.

Another directory or another file can be assigned to the data server device 10R to which the root directory has been assigned. The LOOKUP request is a standard request in the NAS protocol.

The name information storage section 118 of the data server device 10R has at least name information (refer to FIG. 6) on the root directory stored therein. Specifically, names, file IDs and server IDs, which are related to files or directories under the root directory, are stored in the name information storage section 118 of the data server device 10R. Thus, the FD responding section 111 of the data server device 10R acquires data corresponding to the directory with a name “aaa” from the interested name information in response to the LOOKUP request and creates an FD of the directory “aaa” on the basis of the acquired data (in step S202).

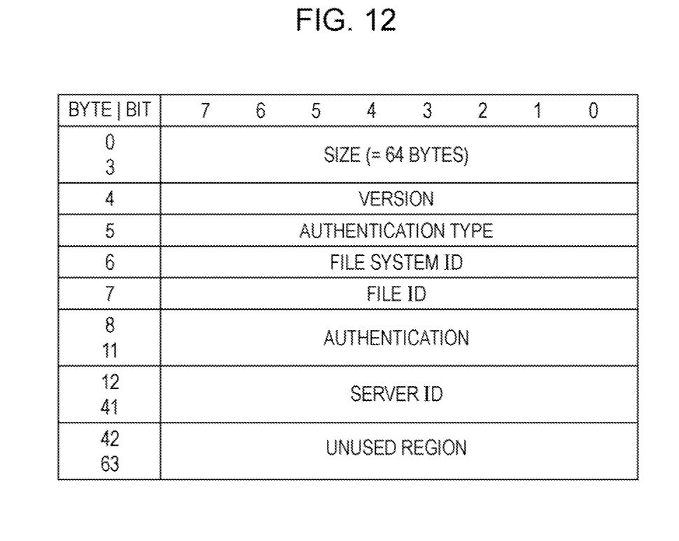

FIG. 12 is a diagram illustrating an example of the file descriptor according to the present embodiment. In FIG. 12, numbers arranged in a horizontal direction indicate bits, numbers arranged in a vertical direction indicate bytes, and data items are arrayed in the FD of 64 bytes.

In the present embodiment, a standard FD format that is used in the NFS is used, and expansion is carried out by storing, in an unused region of the FD, the server ID of the data server device 10 to which the directory or file, which corresponds to the FD, has been assigned. In the standard FD, a region of the 12th to 63rd bytes is an unused region. In the present embodiment, the server ID is stored in a 30-byte region of 12th to 41st bytes. The reason is that when the server ID is stored in the FD, the L7 switch section 32 can identify the data server device 10 to which the file or directory, which corresponds to the FD, has been assigned. The number of bytes of the region in which the server ID is stored may vary depending on the number of bytes of the server ID. The other items are the same as the standard FD, and a description of the other items is omitted. The protocol may be another NAS protocol (such as CIFS) other than the NFS as long as the server ID is stored in an unused region of the FD or a file handle.

In step S202, the FD is created, in which the file ID and the server ID that are included in data that corresponds to the directory “aaa” and is acquired from the name information on the root directory are stored at predetermined positions. As illustrated in FIG. 12, the file ID is stored in a region of the 7th byte.

The FD is data that is disclosed (published) to the NAS client section. The server ID is stored in the unused region so that the existing other items are not changed. Thus, the server ID is hidden from the NAS client section 31. The NAS client section 31 is not affected by the storage of the server ID in the FD (for example, a source code does not need to be changed owing to the storage of the server ID in the FD).

Subsequently, the FD responding section 111 transmits the created FD (of the directory “aaa”) to the FD acquiring section 322. The FD acquiring section 322 causes the received FD to be stored in the FD cache section 323, while the FD is associated with the path name (“\aaa”) of the directory corresponding to the FD in the FD cache section 323 (in step S204).

Then, the FD acquiring section 322 extracts the server ID from the received FD, and transmits a LOOKUP request to the data server device 10 (data server device 10a in this case) corresponding to the interested server ID while specifying the FD and the directory name “bbb” (in step S205). The IP address of the data server device 10a is acquired from the list (stored in the data server list storage section 213) of the information on the data server devices 10 using the server ID as a key. Considering performance during the operation performed on the file, it is preferable that the list of the information be acquired by the client device 30 at a predetermined time such as the time of startup of the client device 30 and stored in (held by) the memory device or auxiliary storage device of the client device 30. In this case, it is possible to reduce the need to perform network communication when the client device 30 acquires the IP address on the basis of the server ID included in the FD. The list of the information on the data server devices 10, which is held by the client device 30, is hereinafter referred to as a “server list”.

Then, the FD responding section 111 of the data server device 10 acquires, in response to the LOOKUP request, data corresponding to the directory “bbb” from the name information on the directory “\aaa” corresponding to the file ID stored in the interested FD and the server ID stored in the interested FD. The FD responding section 111 creates an FD that has, stored therein, the server ID and the file ID that are included in the interested data (in step S206). Subsequently, the FD responding section 111 transmits the created FD to the FD acquiring section 322 (in step S207). The FD acquiring section 322 causes the received FD to be stored in the FD cache section 323, while the FD is associated with the path name (“\aaa\bbb”) of the directory corresponding to the FD in the FD cache section (in step S208).

In this manner, the interested FD of the directory is acquired. The file operation intermediating section 321 acquires the IP address corresponding to the server ID of the FD from the server list. The file operation intermediating section 321 transmits a request (CREATE request) to create a file to the device (“data server device 10b” in this case) that has the interested IP address (in step S209). The interested FD and the file name “ccc” of the file to be created are specified in the request to create the file.

Then, the file creating device selecting section 112 of the data server device 10b references the name information on the directory corresponding to the FD specified by the request to create the file and confirms whether or not data that corresponds to the file with the name “ccc” or a directory with the name “ccc” is included in the interested name information (in step S210). Specifically, the file creating device selecting section 112 confirms whether or not the file with the name “ccc” or the directory with the name “ccc” is already created and exists under the directory “\aaa\bbb”. When the data that corresponds to the file with the name “ccc” or the directory with the name “ccc” is included in the interested name information, an error is transmitted.

When the data that corresponds to the file with the name “ccc” or the directory with the name “ccc” is not included in the interested name information, the file creating device selecting section 112 determines (selects) a data server device 10 (hereinafter referred to as a “child data server device”) in which the file (to be created) is created (in step S211). For example, the file creating device selecting section 112 selects, on the basis of the statistical information (state information) included in the data server information held by the data server device 10b, a child data server device 10 whose current load is relatively low. For example, a data server device 10 that has the maximum available capacity is selected as the child data server device 10 on the basis of the total capacities and the usage rates. In addition, a data server device 10 that has the minimum throughput (immediately previous communication amount) may be selected as the child data server device 10. Furthermore, a data server device 10 to which a parent directory is assigned may be selected as the child data server device 10. Furthermore, the child data server device 10 may be randomly selected. Furthermore, the child data server device 10 may be selected by another method.

Then, the file creation request transferring section 113 transfers the request to create the file to the data server device 10 (data server device 10c in this case) selected as the child data server device (in step S212). In the request to create the file, the FD and the file name “ccc” that are the same as those included in the request transmitted in step S209 are specified.

Then, the file operating section 114 of the data server device 10c creates the file specified by the request to create the file and causes the created file to be stored in the file body storage section 117 of the data server device 10c (in step S213). With the creation of the file, an FD in which the file ID of the created file is stored is created. The file operating section 114 causes the server ID of the data server device 10c to be stored in the FD. Then, the file operating section 114 transmits the created FD (i.e., the FD of “\aaa\bbb\ccc”) to the data server device 10b in response to the request to create the file (in step S214).

The file creation request transferring section 113 of the data server device 10b additionally registers data corresponding to the file “ccc” in the name information on the directory “\aaa\bbb” on the basis of the transmitted FD (in step S215). Specifically, the data that corresponds to the file “ccc” is stored in the name information on the directory “\aaa\bbb”, while the file name “ccc” of the file received in step S210 is associated with the file ID and the server ID that are included in the FD transmitted in step S214.

When the data server device 10b is selected as the child data server device in step S211, step S212 is not performed. In this case, the file operating section 114 of the data server device 10b performs the same processes as steps S212 and S214.

Then, the file creation request transferring section 113 transmits the FD of “\aaa\bbb\ccc” to the L7 switch section 32 (in step S216). The file operation intermediating section 321 of the L7 switch section 32 associates the received FD with the path name “\aaa\bbb\ccc” of the created file and causes the received FD to be stored in the FD cache section 323 (in step S217). After that, the file operation intermediating section 321 transmits the interested FD to the NAS client section 31 of the device that has transmitted the request to create the file. The NAS client section 31 can request the file operation intermediating section 321 to write data in the file “\aaa\bbb\ccc” and the like using the FD. In this case, the file operation intermediating section 321 transmits, to the data server device corresponding to the server ID stored in the interested FD, a request to write the data in the interested file and the like. When the client device 30 has the FD, the client device 30 directly transmits the request to the data server device 10 that has the file corresponding to the interested FD. Thus, when the client device 30 has the FD, it is considered that performance is not affected very much by the distribution of the name information. The IP address that corresponds to the server ID is acquired from the server list, for example.

FIG. 11 illustrates the process of creating a file. A process of creating a directory is performed according to the same procedures as illustrated in FIG. 11.

In the present embodiment, although the request to create a file in step S209 is the same as the request to create a file in step S212, the process that is performed by the data server device 10b in response to the request is different from the process that is performed by the data server device 10c in response to the request. The reason is that even when the requests are the same, the NAS server section 11 performs a process that varies depending on whether or not a directory that corresponds to the FD specified in the request to create the file is assigned to the interested data server device 10. Specifically, when the directory that corresponds to the FD specified in the request to create the file is assigned to the data server device 10, a process that is the same as the process performed by the data server device 10b is performed. On the other hand, when the directory that corresponds to the FD specified in the request to create the file is not assigned to the data server device 10, a process that is the same as the process performed by the data server device 10c is performed. Whether or not the directory that corresponds to the FD specified in the request to create the file is assigned to the data server device 10 is determined on the basis of whether or not name information in which the file ID and the server ID that are stored in the interested FD are registered as data of a current directory is stored in the name information storage section 118 of the interested data server device 10.

In the present embodiment, the result of determining whether or not the directory that corresponds to the FD specified in the request to create the file is assigned to the data server device 10 is the same as the result of determining whether or not the request to create the file is received by the L7 switch section 32. The process that is performed in response to the request to create the file may be selected on the basis of the latter determination result. In this case, when the IP address of the device that has transmitted the request to create the file is not stored in the data server list storage section 213, it is determined that the request to create the file is transmitted from the L7 switch section 32.

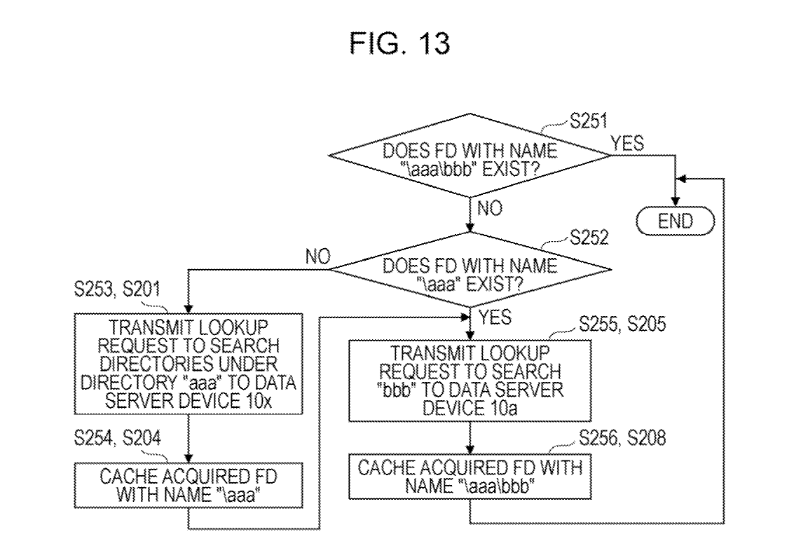

Next, the details of a process that is performed by the FD acquiring section 322 and described with referenced to FIG. 11 are described. FIG. 13 is a diagram illustrating a process of acquiring a file descriptor.

In step S251, the FD acquiring section 322 confirms whether or not the FD cache section 323 has, stored therein, an FD that corresponds to the directory “\aaa \bbb” and is to be acquired by the FD acquiring section 322 requested by the file operation intermediating section 321. When the FD cache section 323 has the FD stored therein, the FD acquiring section 322 outputs the FD to the file operation intermediating section 321.

When the FD cache section 323 does not have the FD, the FD acquiring section 322 confirms whether or not the FD cache section 323 has, stored therein, an FD that corresponds to the directory “\aaa” at one level above the directory “\aaa\bbb” (in step S252). In other words, the cached FD is searched while directory layers are searched on a layer basis. When the FD cache section 323 does not have the FD that corresponds to the directory “\aaa”, the FD acquiring section 322 transmits a LOOKUP request to search the directory “\aaa” immediately under the root directory to a data server device 10x to which the root directory “aaa” has been assigned (in step S253). In FIG. 13, step numbers indicated in parentheses correspond to the steps illustrated in FIG. 11.

Then, the FD acquiring section 322 causes the FD transmitted by the FD responding section 111 of the data server device 10x to be stored in the FD cache section 323 while the FD is associated with the path name “\aaa” of the directory corresponding to the FD (in step S254).

After step S254 or S252, when the FD cache section 323 has, stored therein, the FD that corresponds to the directory “\aaa”, the FD acquiring section 322 transmits a LOOKUP request to search the directory “bbb” to the data server device 10a corresponding to the server ID stored in the FD corresponding to the directory “\aaa” while specifying the interested FD (in step S255). Then, the FD acquiring section 322 causes the FD transmitted by the FD responding section 111 of the data server device 10a to be stored in the FD cache section 323, while the FD is associated with the path name (“\aaa\bbb”) of the directory corresponding to the interested FD (in step S256). Subsequently, the FD acquiring section 322 outputs the interested FD to the file operation intermediating section 321.

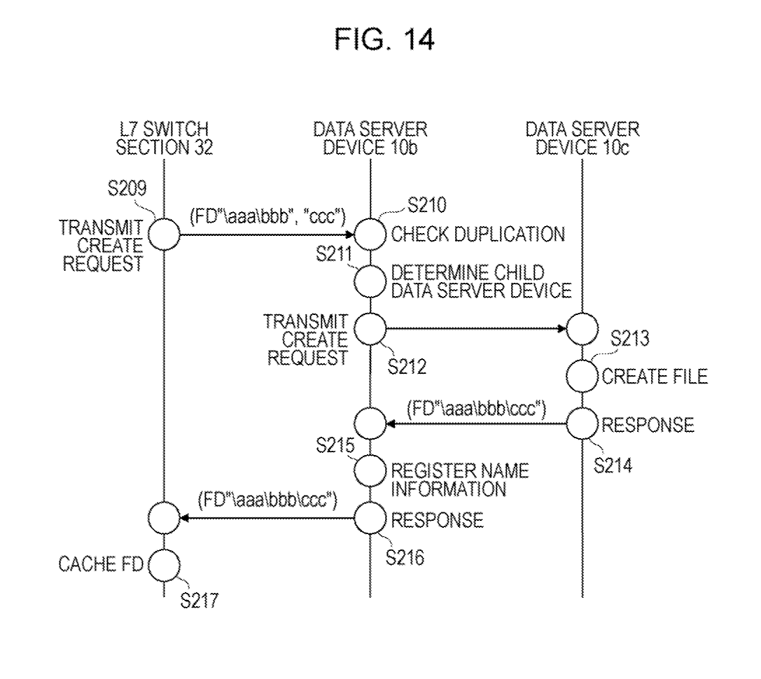

In this manner, the acquired FD is cached in the FD cache section 323. In addition, it is confirmed whether or not the interested FD is stored in the FD cache section 323. When the FD cache section 323 has the FD stored therein, the interested FD is used. Thus, when the FD cache section 323 has, stored therein, the FD of the directory “\aaa\bbb”, the process illustrated in FIG. 11 is performed as illustrated in FIG. 14.

FIG. 14 is a diagram illustrating a process of creating a file when a file descriptor of a parent directory is cached. In FIG. 14, steps that are the same as illustrated in FIG. 11 are indicated by the same step numbers and a description of the steps is omitted.

Comparing FIG. 14 with FIG. 11, steps S201 to S208 do not need to be performed in the process illustrated in FIG. 14 and are different from the process illustrated in FIG. 11. In the process illustrated in FIG. 14, the process of searching a FD of the directory “\aaa\bbb” does not need to be performed.

Thus, the caching of the FD can reduce the frequency of the LOOKUP request. As a result, it is possible to reduce the possibility of degradation (owing to the distribution of the name information) of performance. The capacity of the FD cache section 323 may be selected on the basis of specifications of the device that is actually used. As an algorithm of determining an FD to be discarded when the capacity is not sufficient, a known technique (for example, First-In First-Out (FIFO), Least Recently Used (LRU) or the like) may be used.

The process of creating a file is described above. A process that is basically the same as the process of creating a file may be performed to write or read an FD. Specifically, the L7 switch section 32 transmits a request to write or read an FD to the data server device 10 corresponding to the server ID stored in the FD of the file to be written or read.

As described above, in the file management system 1 according to the first embodiment, a first data server device 10 that receives a request to create a file makes a second data server device 10 create the file and registers a server ID corresponding to the file and the file ID of the file in the name information on a directory assigned to the first data server device 10. Since the data server devices 10 perform the aforementioned operations, the name information and the bodies of the files are distributed in and managed by the plurality of data server devices 10. As a result, a meta server that centrally manages name information in a conventional cluster system is not necessary, and the file management system 1 is released from various limits that are caused by the meta server. Specifically, scalability (expandability) of the file management system 1 can be improved. In other words, the file management system 1 can include more (theoretically unlimited number of) data server devices 10 compared with the case where the meta server exists.

In addition, it is possible to eliminate a bottleneck caused by concentration of access on the meta server. Since the name information is distributed, the distributed name information can be accessed in parallel. Thus, performance of parallel operations that are performed on files or directories can be improved. The improvement of the performance of the parallel operations is more noticeable as the number of data server devices 10 is increased.

In addition, the L7 switch section 32 solves the distributed name information and provides, to the NAS client section 31, a communication interface that is the same as or similar to the conventional NAS protocol. Thus, the plurality of data server devices 10 are hidden by the L7 switch section 32. In addition, the management of files, which is performed by the plurality of data server devices 10, is hidden by the L7 switch section 32. Therefore, the NAS client section 31 that is used in a conventional technique can be easily deployed in the file management system 1 according to the present embodiment.

The conventional NAS protocol can be used between the L7 switch section 32 and each of the data server devices 10. Thus, it is possible to reduce the amount of changes in the data server devices 10.

In the present embodiment, in the process of creating a file, a process that is not performed in the conventional technique, for example, a process of transferring a request to create a file from a certain data server device 10 to another data server device 10, is performed. However, after the creation of the file, the file can be directly accessed on the basis of the server ID included in the FD. In addition, the frequency of use of the command to create a file is extremely low (approximately 1%) among various types of commands related to operations to be performed on files. Thus, even when the number of steps of the process of creating a file is increased, it cannot be considered that the entire performance is largely affected by the increase.

Next, the second embodiment is described. The second embodiment describes locking (exclusive control) of a file that is distributed in and managed by the file management system 1. Basically, functions or processes, which are described in the second embodiment, are added to the first embodiment. Thus, the functions or processes, which are described in the first embodiment, are used in the second embodiment without changing the functions or processes.

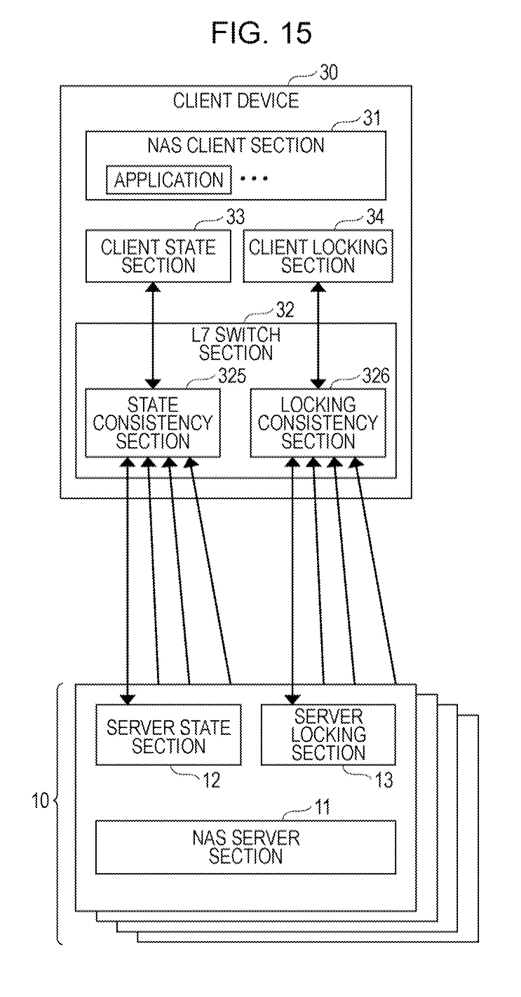

FIG. 15 is a diagram illustrating an example of a functional configuration of a client device according to the second embodiment and an example of a functional configuration of a data server device according to the second embodiment. In FIG. 15, parts that are the same as the parts illustrated in FIG. 2 are indicated by the same reference numerals, and a description of the parts is omitted.

Referring to FIG. 15, the client device 30 further includes a client state section 33 and a client locking section 34. The client state section 33 is a daemon program called statd in general NFS. The client locking section 34 is a daemon program called lockd in the general NFS. The statd and lockd of the client device 30 have a function that is included in the client device 30 and related to locking of a file in the NFS. The locking of a file allows the file to be exclusively used.

The data server devices 10 each further include a server state section 12 and a server locking section 13. The server state section 12 is a daemon program called statd in the general NFS. The server locking section 13 is a daemon called lockd in the general NFS. The statd and the lockd of the data server device have a function that is included in the data server device and related to locking of a file in the NFS.

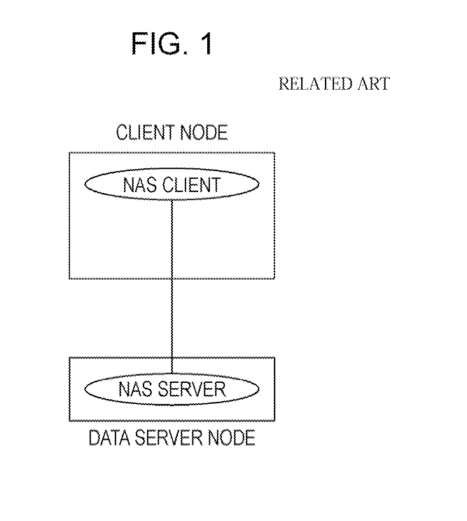

When the relationship between the single client device 30 and the data server device 10 is a one-to-one relationship as illustrated in FIG. 1, the client state section 33 and the server state section 12 can directly communicate with each other. For example, in response to restart of the client device 30, the client state section 33 transmits, to the server state section 12, a NOTIFY message to notify the server state section 12 of the restart of the client device 30. In response to restart of the data server device 10, the server state section 12 transmits, to the client state section 33, a NOTIFY message to notify the client state section 33 of the restart of the data server device 10. Thus, the receiving side detects the restart of the transmitting side through the NOTIFY message, and a process of maintaining consistency of locking can be performed. In addition, the client locking section 34 transmits, to the server locking section 13, a request to lock or unlock (release locking of) a file in response to a request transmitted from the NAS client section 31. The server locking section 13 locks or unlocks the file on the basis of the request transmitted from the client locking section 34.

In the present embodiment, the plurality of data server devices 10 are virtualized by the L7 switch section 32. The L7 switch section 32 has a state consistency section 325 and a locking consistency section 326 that are daemon programs to integrate and virtualize the server state sections 12 of the data server devices 10 or the server locking sections 13 of the data server devices 10. The state consistency section 325 is treated as a single server state section 12 by the client state section 33 and treated as a client state section 33 by the server state section 12. The locking consistency section 326 is treated as a single server locking section 13 by the client locking section 34 and treated as a client locking section 34 by the server locking section 13. Known statd can be used as the client state section 33 and the server state sections 12 by the virtualization of the L7 switch section 32 (state consistency section 325 and locking consistency section 326), and known lockd can be used as the client locking section 34 and the server locking sections 13 by the virtualization of the L7 switch section 32 (state consistency section 325 and locking consistency section 326).

In FIG. 15, the other constituent elements illustrated in FIG. 4 are not illustrated and are omitted for convenience of illustration.

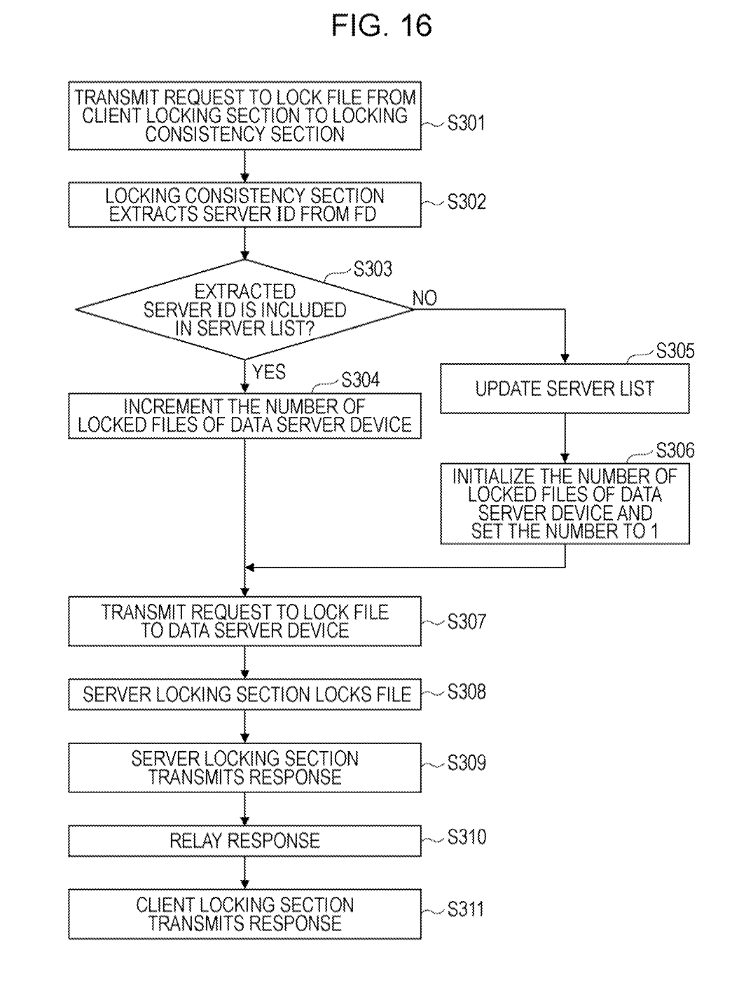

Next, a process according to the second embodiment is described. FIG. 16 is a diagram illustrating a process of locking a file.

In step S301, in response to a request to lock a file from the NAS client section 31, the client locking section 34 transfers the request to lock the file to the locking consistency section 326. An FD of the file to be locked is specified in the request to lock the file.

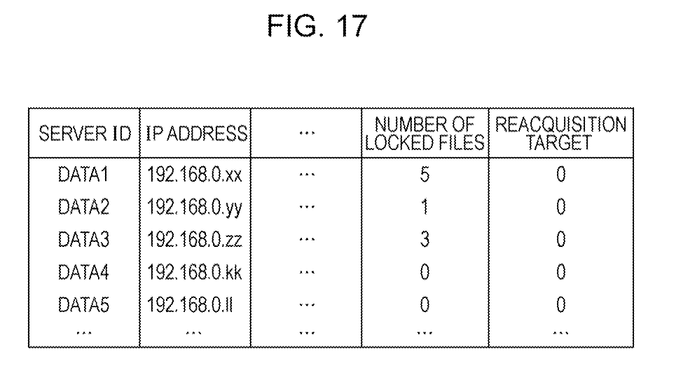

In response to reception of the request to lock the file, the locking consistency section 326 extracts a server ID from the FD specified in the request to lock the file (in step S302). Subsequently, the locking consistency section 326 confirms whether or not the extracted server ID is included in the server list (in step S303). The server list is managed by the client device 30 according to the second embodiment in a form illustrated in FIG. 17.

FIG. 17 is a diagram illustrating an example of the form of management of the server list in the client device according to the second embodiment. As illustrated in FIG. 17, an item for the number of locked files and an item for a reacquisition target are added to the list that indicates information on the data server devices 10 and is acquired by the server monitoring device 20 so that data is managed as the server list by the client device 30 according to the second embodiment. The number of locked files is the number of locked files in each of the data server devices 10. The reacquisition target is described later. The statistical information on the data server devices 10 may not be managed (held) by the client device 30.

When the extracted server ID is included in the server list (Yes in step S303), the locking consistency section 326 adds 1 to the number of locked files corresponding to the interested server ID in the server list (in step S304).

On the other hand, when the extracted server ID is not included in the server list (No in step S303), the locking consistency section 326 acquires the latest list (latest version of the list) of information on the data server devices 10 from the server monitoring device 20 and updates the server list on the basis of the list of the information (in step S305). In this case, the server list is updated so that the server list is the same as the list of the information on the data server devices 10. When the interested server ID is newly added to the server list by the updating of the server list, the locking consistency section 326 stores 1 in the item for the number of locked files corresponding to the interested server ID in the server list (in step S306). When the interested server ID is not included in the updated server list, the locking consistency section 326 transmits an error to the client locking section 34. The client locking section 34 transfers the error to the NAS client section 31.

After step S304 or S306, the locking consistency section 326 transfers the request to lock the file to the server locking section 13 of the data server device 10 corresponding to the interested server ID through the interface device 105 (in step S307). The IP address of the data server device 10 corresponding to the interested server ID is specified on the basis of the server list. However, when the IP address is used as the server ID, it is not necessary to reference the server list.

When the server locking section 13 receives the request to lock the file, the server locking section 13 locks the file that corresponds to the file ID included in the FD specified by the request to lock the file (in step S308). A function of an existing file system may be used to lock the file. In this case, the locking of the file is managed by the file system using the memory device 103 or the auxiliary storage device 102. Then, the server locking section 13 transmits, to the locking consistency section 326, a response that indicates the result (success or failure) of the locking (in step S309). The locking consistency section 326 transfers (relays) the response to the client locking section 34 (in step S310). The client locking section 34 transmits a response to the NAS client section 31 on the basis of the received response (in step S311).

In this manner, the file that is requested by the NAS client 31 is locked. Unlocking of the file is performed according to the same procedures as illustrated in FIG. 16.

In the present embodiment, even when files are distributed in and managed by the plurality of data server devices 10, the NAS client section 31 can lock a file without being aware of which data server device 10 has the file to be locked. The reason is that the server ID is stored in the FD and the locking consistency section 326 determines, on the basis of the server ID, the device to be requested to lock the file.

Next, a process that is performed when a certain data server device 10 restarts is described. The restart of the data server device 10 is performed owing to a failure, maintenance or the like.

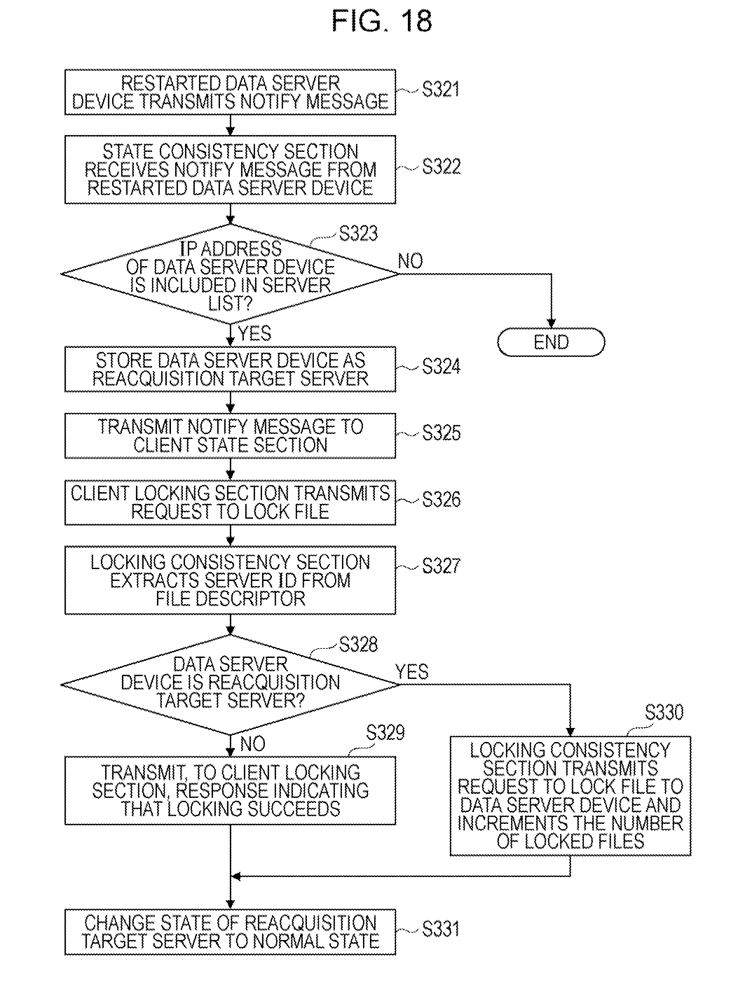

FIG. 18 is a diagram illustrating the process that is performed in response to the restart of the data server device.

The server state section 12 of the restarted data server device 10 transmits a NOTIFY message (in step S321). The NOTIFY message is a standard message in the NFS. When the state consistency section 325 of the client device 30 receives the NOTIFY message (in step S322), the state consistency section 325 determines whether or not the IP address of the device that has transmitted the NOTIFY message is included in the server list (in step S323). When the IP address is not included in the server list (No in step S323), the state consistency section 325 terminates the process.

When the IP address is included in the server list (Yes in step S323), the state consistency section 325 stores the data server device 10 corresponding to the IP address as a reacquisition target server (in step S324). Specifically, the state consistency section 325 sets a value of a “reacquisition target” to 1 for the interested data server device 10 (interested IP address) in the server list. In addition, the state consistency section 325 sets the number of locked files to 0 in the server list, while the number of locked files, which is set to 0, is stored for the interested data server device 10 (interested IP address).

It should be noted that the “reacquisition” means reacquisition of locking. Specifically, the restarted data server device 10 sets the locked state of a file to a rebuilt state of the file. The rebuilt state of the file means that when a request to lock the file is not provided for a predetermined time period, the locking of the file is automatically released. Thus, even if the data server device 10 and the client device 30 simultaneously restart while all files are locked, the locking can be released.

When the NAS client section 31 needs to keep a certain file locked, it is necessary to request to lock the file again. Requesting to lock the file again means the reacquisition. In the NFS, the locking states (locked states or unlocked states) of files in the data server device and the client device are synchronized or consistent using the NOTIFY message and the request to lock the file in response to the NOTIFY message.

Subsequently, the state consistency section 325 transfers (relays) the NOTIFY message to the client state section 33 (in step S325). The client state section 33 notifies the NAS client section 31 of the NOTIFY message. In response to the NOTIFY message, the NAS client section 31 transmits a request to lock the file to the client locking section 31 so as to request the client locking section 31 to lock the file that needs to be continuously locked. The client locking section 34 transmits the request to lock the file to the locking consistency section 326 (in step S326).

The locking consistency section 326 extracts the server ID from the FD specified in the request to lock the file (in step S327). Subsequently, the locking consistency section 326 determines whether or not the data server device 10 that corresponds to the server ID is a reacquisition target server (in step S328). Specifically, the locking consistency section 326 determines whether or not the value of the “reacquisition target” that corresponds to the server ID is “1”.

When the data server device 10 that corresponds to the server ID is not the reacquisition target server (No in step S328), the locking consistency section 326 transmits, to the client locking section 34, a response that indicates that locking succeeds (in step S329). In this case, the data server device 10 that stores the file to be locked is not the restarted data server device 10. Specifically, since the data server device 10 is virtualized for the NAS client section 31 by the L7 switch section, the locking is re-requested regardless of which data server device 10 has transmitted the NOTIFY message. If the locking consistency section 326 issued a request to lock the file, the request to lock the file would be an error since the file requested to be locked is already locked. When the NAS client section receives the error, the locking state (of the file) that is detected by the NAS client section 31 is not consistent with the locking state (of the file) that is detected by the data server device 10. The NAS client section 31 detects that the file is in the unlocked state owing to the error of the locking, while the data server device 10 detects that the file is locked by the NAS client section 31. To avoid this inconsistency, the integration section 326 does not issue a request to lock the file and transmits the response that indicates that the locking succeeds in step S329.

On the other hand, when the data server device 10 that corresponds to the server ID is the reacquisition target server (Yes in step S328), the locking consistency section 326 transmits a request to lock the file to the data server device 10 corresponding to the interested server ID, and increments the number of locked files corresponding to the server ID in the server list (in step S330). A process that is performed in response to the request (to lock the file) transmitted from the locking consistency section 326 is the same as the process of steps S308 and later illustrated in FIG. 16. The server locking section 13 that receives a request to lock a file releases the rebuilt state of the file requested to be locked. Thus, the file is excluded from files to be automatically released from the locked states after the predetermined time period.

When a predetermined time elapses after the reception of the NOTIFY message in step S322, the locking consistency section 326 performs step S331. In other words, the locking consistency section 326 waits to receive the request to lock the file from the client locking section 34 for the predetermined time after the reception of the NOTIFY message. The reason is that the locking consistency section 326 cannot determine the timing (i.e., the number of files re-requested by the NAS client section 31 to be locked) of termination of transmission of the request to lock the file. Thus, when the predetermined time elapses, the process proceeds to step S331.

In step S331, the locking consistency section 326 changes the state of the reacquisition target server to a normal state. Specifically, the locking consistency section 326 sets, in the server list, the value of the “reacquisition target” to 0 for the data server device 10 stored as the reacquisition target server.

In the present embodiment, even when the data server device 10 restarts, the locking states of the files can be synchronized between the NAS client section 31 and the data server device 10 by the state consistency section 325 and the locking consistency section 326. In addition, the state consistency section 325 and the locking consistency section 326 intermediate to allow the NAS client section 31 and the data server device 10 to maintain the standard process defined by the NFS.

Next, a process that is performed when the client device 30 restarts is described.

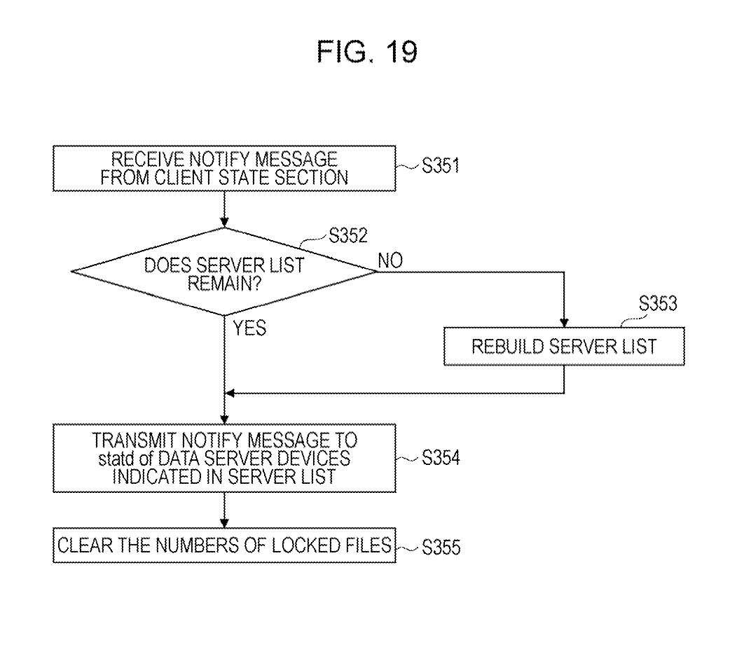

FIG. 19 is a diagram illustrating the process that is performed when the client device restarts. In response to restart of the client device 30, locking information that is stored in a memory of the NAS client section is lost. The locking information is information on a list of locked files. The client state section 33 transmits a NOTIFY message to the state consistency section 325.

In step S351, the state consistency section 325 receives the NOTIFY message. Then, the state consistency section 325 determines whether or not the server list remains (in step S352). For example, when the server list is already stored in a volatile storage medium, the server list is lost owing to the restart of the client device 30. On the other hand, when the server list is already stored in a nonvolatile storage medium such as an HDD, the server list remains.

When the server list does not remain (No in step S352), the state consistency section 325 acquires information stored in the data server list storage section 213 of the server monitoring device 20 and rebuilds the server list on the basis of the acquired information (in step S353). In order to rebuild the server list, the numbers of locked files and reacquisition targets are initialized and set to 0.

Subsequently, the state consistency section 325 transmits a NOTIFY message through the interface device 105 to all IP addresses (data server devices 10) that are indicated in the server list 10 (in step S354). When the server list remains, the devices to which the NOTIFY message is transmitted may be limited to data server devices 10 that are indicated in the server list to have 1 or more locked files. Thus, when the number of data server devices 10 is extremely large, it is possible to noticeably reduce a communication load.

When the server state section 12 that receives the NOTIFY message releases, among locked files in the data server device 10, all locked states of files requested by the device that has transmitted the NOTIFY message. Specifically, the files requested to be locked are managed by the data server device 10. This step is a process defined by the NFS. Then, the state consistency section 325 sets all the numbers of locked files in the server list to 0 (in step S355).

In the present embodiment, even when the client device 30 restarts, it is possible to appropriately release the locking of files distributed in the plurality of data server devices 10. Thus, it is possible to synchronize the locking states of files between the NAS client section 31 and the data server devices 10. In addition, the state consistency section 325 intermediates to allow the NAS client section 31 and the data server devices 10 to maintain the process defined in the NFS.

An applicable range of the exclusive control described in the second embodiment is not limited to the file management system 1 that has the structure described in the first embodiment. Specifically, the exclusive control described in the second embodiment can be applied to another file management system that has a structure to store information on the identifications of NAS server devices in an FD.

The embodiments of the invention are described above. The invention is not limited to the specific embodiments and can be variously modified and changed within the gist of the invention described in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing a program causing a computer to execute a process, the computer being connected through a network to a plurality of file management devices which store a plurality of files distributed in the plurality of file management devices, the process comprising:
extracting an identification information of a file management device by a file descriptor specified in a request for locking a file, the request being generated by an application being activated on the computer; and
transmitting the request for locking the file through an interface section to the file management device corresponding to the identification information.

2. The computer-readable, non-transitory medium according to claim 1, the process further comprising:
relaying, to the application, a notification that indicates restart of the file management device and has been transmitted from the file management device; and
transmitting the request for locking the file to the file management device when the extracted identification information is information on the identification of the file management device that has transmitted the notification that indicates the restart, and
transmitting, to the application, a response that indicates that locking succeeded when the extracted identification information is not the information on the identification of the file management device that has transmitted the notification that indicates the restart.

3. The computer-readable, non-transitory medium according to claim 2, the process further comprising:
transmitting, to the plurality of file management devices, the notification that indicates restart of the computer in response to the restart of the computer.

4. The computer-readable, non-transitory medium according to claim 3,
wherein in the transmitting the request for the locking file through the interface section, the identification information of the file management device is extracted by the file descriptor specified in the request for locking the file in response to the request being generated by the application, and locking information that indicates existence or non-existence of a file that is associated with the identification information is stored in a storage region, and
wherein in the transmitting the notification, the notification that indicates the restart of the computer is transmitted through the interface section to the file management device that has the identification information stored in the storage region.

5. A file management method that a computer executes, the computer being connected through a network to a plurality of file management devices storing a plurality of files distributed in the plurality of file management devices executes, the file management method comprising:
extracting information on the identification of a file management device from a file descriptor specified in a request for locking a file, the request being generated by an application being activated on the computer; and
transmitting the request for locking the file through an interface section to the file management device corresponding to the identification information.

6. The file management method according to claim 5, the method further comprising:
relaying, to the application, a notification that indicates restart of the file management device and has been transmitted from the file management device; and
transmitting the request for locking the file to the file management device when the extracted identification information is information on the identification of the file management device that has transmitted the notification that indicates the restart, and
transmitting, to the application, a response that indicates that locking succeeded when the extracted identification information is not the information on the identification of the file management device that has transmitted the notification that indicates the restart.

7. The file management method according to claim 6, wherein the notification that indicates restart of the computer in response to the restart of the computer is transmitted to the plurality of file management devices.

8. The file management method according to claim 7,
wherein in the transmitting the request for the locking file through the interface section, the identification information of the file management device is extracted by the file descriptor specified in the request for locking the file in response to the request being generated by the application, and locking information that indicates existence or non-existence of a file that is associated with the identification information is stored in storage region, and
wherein in the transmitting the notification, the notification that indicates the restart of the computer is transmitted through the interface section to the file management device that has the identification information stored in the storage region.

9. An information processing device that is connected through a network to a plurality of file management devices storing a plurality of files distributed in the plurality of file management devices, the information processing device equipped with an intermediating section, the intermediating section comprising:
an extracting section configured to extract an identification information of a file management device from a file descriptor specified in a request for locking a file, the request being generated by an application being activated on the computer; and
a transmitting section configured to transmit the request for locking the file through an interface section to the file management device corresponding to the identification information.

10. The information processing device according to claim 9,
wherein the intermediating section relays, to the application, a notification that indicates restart of the file management device and has been transmitted from the file management device,
wherein the intermediating section transmits the request for locking the file to the file management device when the extracted identification information is information on the identification of the file management device that has transmitted the notification that indicates the restart, and
wherein the intermediating section transmits, to the application, a response that indicates that locking succeeded when the extracted identification information is not the information on the identification of the file management device that has transmitted the notification that indicates the restart.

11. The information processing device according to claim 9, wherein the intermediating section transmits, to the plurality of file management devices, the notification that indicates restart of the information processing device in response to the restart of the information processing device.

12. The information processing device according to claim 11,
wherein the intermediating section extracts the information on the identification of the file management device by the file descriptor specified in the request for locking the file in response to the request generated by the application,
wherein the intermediating section extracts causes locking information to be stored in storage region, the locking information indicating existence or non-existence of a file that is associated with the identification information, and
wherein the intermediating section extracts transmits, in response to the restart of the information processing device, the notification that indicates the restart of the information processing device through the interface section to the file management device that has the identification information stored in the storage region.

13. An information processing device that is connected through a network to a plurality of file management devices storing a plurality of files distributed in the plurality of file management devices, the information processing device comprising:
a processor configured to execute a procedure, the procedure comprising:
extracting an identification information of a file management device by a file descriptor specified in a request for locking a file, the request being generated by an application being activated on the computer; and
transmitting the request for locking the file through an interface section to the file management device corresponding to the identification information.
